(19) United States
(12) Patent Application Publication
(10) Pub. No.: US 2021/0214092 A1
(43) Pub. Date: Jul. 15, 2021

(54) STRUCTURE MOUNTED AIRBAG SYSTEMS

(71) Applicant: AmSafe, Inc., Phoenix, AZ (US)

(72) Inventors: Hyunsok Pang, Chandler, AZ (US); James Christopher Wilkerson, Phoenix, AZ (US)

(21) Appl. No.: 16/739,027

(22) Filed: Jan. 9, 2020

(51) Int. Cl. B64D 25/00; B60R 21/20; B60R 21/231; B60R 21/00

(52) U.S. Cl. CPC B64D 25/00; B60R 21/20; B64D 2201/00; B60R 2021/0048; B60R 21/231

(57) ABSTRACT

Airbags for use in aircraft and other vehicles are described herein. In some embodiments, an airbag can deploy from a structure forward of a seated occupant at a generally upward angle relative to a longitudinal axis of the aircraft. The distal end portion of the airbag can include a recessed impact surface portion configured to receive the head and/or neck of the seat occupant.

### TECHNICAL FIELD

The following disclosure relates generally to occupant restraint systems for use in aircraft and other vehicles and, more particularly, to occupant restraint systems having airbags.

### BACKGROUND

Airbags can protect occupants from strike hazards in automobiles, aircraft, and other vehicles. In automobiles, for example, airbags can be stowed in the steering column, dashboard, side panel, or other location. In the event of a collision or other dynamic event of sufficient magnitude, a sensor detects the event and transmits a corresponding signal to an initiation device (e.g., a pyrotechnic device) on an airbag inflator. The signal causes the inflator to release compressed gas into the airbag, rapidly inflating the airbag and deploying it in front of the driver or other occupant to cushion their impact with forward objects.

Some aircraft also include airbags for occupant safety. For example, some aircraft include airbags that are carried on seat belts which can be secured around an occupant's waist in a conventional manner. The airbag is typically stowed under a removable cover on the seat belt. In the event the aircraft experiences a forward impact or other significant dynamic event, the airbag immediately inflates, displacing the cover and rapidly deploying in front of the occupant to create a cushioning barrier between the occupant and a seat back, partition, monument, or other structure in the seating area. Aircraft can also include airbags that are positioned on seat backs and other structures in front of a passenger. The design of these airbags, however, can present challenges to ensure that the airbags are properly positioned upon inflation to protect the passenger in a range of seating positions.

### BRIEF DESCRIPTION OF THE DRAWINGS

FIG. 1 is an isometric side view of an aircraft seating area configured in accordance with some embodiments of the present technology.

FIGS. 2A-2C are a series of isometric side views of the aircraft seating area of FIG. 1 illustrating the deployment of an airbag configured in accordance with some embodiments of the present technology.

FIGS. 3A and 3B are top views of the embodiments shown in FIGS. 2B and 2C, respectively.

FIGS. 4A and 4B are a series of isometric side views of the aircraft seating area of FIG. 1 illustrating the deployment of an airbag configured in accordance with some embodiments of the present technology.

FIGS. 5A-5D are a series of isometric, top, side, and flat panel views, respectively, of an airbag configured in accordance with some embodiments of the present technology.

FIG. 6 is a partially schematic isometric view of an airbag assembly configured in accordance with some embodiments of the present technology.

FIGS. 7A-7C are a series front-isometric, rear-isometric, and side views, respectively, of the airbag assembly of FIG. 6 positioned in an aircraft structure in accordance with some embodiments of the present technology.

FIGS. 8A and 8B are a series of isometric side views of the aircraft seating area of FIG. 1 illustrating the deployment of an airbag configured in accordance with some embodiments of the present technology with a child in a child seat in a forward orientation.

FIG. 9 is an isometric side view of the aircraft seating area of FIG. 1 illustrating the deployment of an airbag configured in accordance with some embodiments of the present technology with a child in a child seat in a rearward orientation.

### DETAILED DESCRIPTION

The following disclosure describes various embodiments of airbags that inflate and deploy in front of a seat occupant to provide a cushioning barrier between the occupant and a forward strike hazard. In some embodiments, the airbag deploys from a housing positioned within a forward structure in an aircraft seating area in response to a crash event. In the fully inflated state, a longitudinal axis of the airbag extends at an upward angle relative to a longitudinal axis of the aircraft. The airbag includes an impact surface portion that defines a recess for receiving the head and/or neck of the seat occupant during the crash event. In some embodiments, the airbag is configured to bend or deflect upwardly in response to the occupant striking the impact surface portion. As described in greater detail below, and without wishing to be bound by theory, the foregoing and other features of the airbags and the airbag systems described herein are expected to reduce and/or mitigate injuries that a seat occupant might otherwise incur by striking the forward structure.

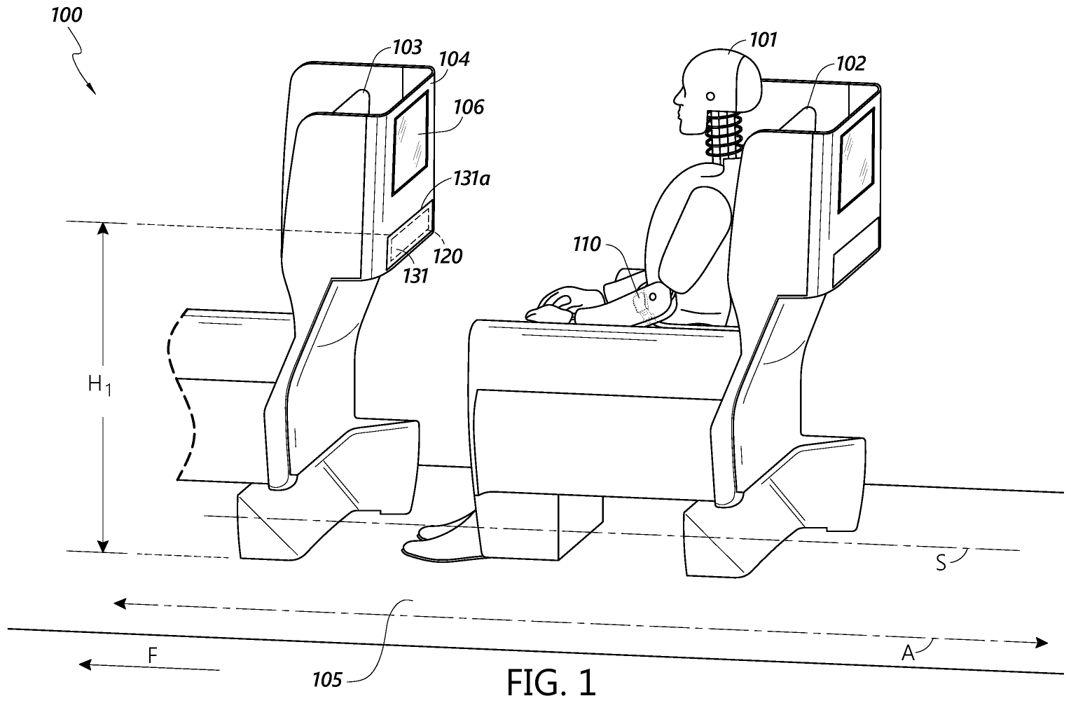

Certain details are set forth in the following description and in FIGS. 1A-9 to provide a thorough understanding of various embodiments of the present technology. In other instances, other details describing well-known structures, materials, methods and/or systems often associated with airbags, airbag inflation systems and related circuitry, aircraft seating areas, seat belts, etc. in aircraft and other vehicles are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 102 is first introduced and discussed with reference to FIG. 1.

As used herein, the terms “rapid deceleration event”, “dynamic event”, “crash event,” and the like refer to events imparting a substantial force (e.g., a deceleration force) on the vehicle and/or occupants seated within the vehicle, including but not limited to a crash, a collision, a maneuver to avoid a crash, a maneuver to avoid a collision, etc.

As used herein, the use of relative terminology, such as “about”, “approximately”, “substantially” and the like refer to the stated value plus or minus ten percent. For example, the use of the term “about 100” refers to a range of from 90 to 110, inclusive. In instances where relative terminology is used in reference to something that does not include a numerical value, the terms are given their ordinary meaning to one skilled in the art.

FIG. 1 is an isometric side view of a seat occupant 101 positioned in a seat 102 in a seating area 100. In the illustrated embodiment, the seating area 100 is located in an aircraft, such as in a passenger cabin of a commercial or private aircraft. For example, the seat 102 can be at least generally similar to a conventional seat in, for example, a first class cabin, a business class cabin, or a coach cabin of a commercial passenger aircraft. The seat 102 can include a seatbelt 110 for releasably retaining the occupant 101 in the seat 102. Although illustrated as a two-point lap belt, the seatbelt 110 can also include a three-point restraint, a four-point restraint, or any other suitable seatbelt known in the art.

In the illustrated embodiment, the seat 102 faces forward, or at least generally forward, in direction F toward the front of the aircraft. Accordingly, in the illustrated embodiment, a centerline S of the seat 102 extends parallel to, or at least approximately parallel to, a longitudinal axis A of the aircraft (e.g., a longitudinal axis of the aircraft fuselage). The longitudinal axis A can also represent the centerline of the aircraft and can be parallel to a cabin floor 105. In other embodiments, the seat 102 can be positioned such that the centerline S is oriented at an angle relative to the longitudinal axis A. For example, the seat centerline S can be positioned at angles of from about 5 degrees to about 90 degrees, or from about 10 degrees to about 45 degrees, relative to the longitudinal axis A. In further embodiments, the seat 102 can be positioned in other orientations and/or other settings. Additionally, as those of ordinary skill in the art will appreciate, although only one seat 102 is illustrated in FIG. 1, in other embodiments additional seats can be positioned to one or both sides of the seat 102 to comprise a row of seats. For example, seat 102 could be in a row having one, two, three, or more additional seats.

The restraint systems described herein can be used to protect occupants in a wide variety of vehicles, including other types of aircraft (e.g., both fixed- and rotary-wing aircraft), land vehicles (e.g., automobiles), watercraft, etc., and with a wide variety of seating arrangements and orientations, such as center aisle seats, outer aisle seats, seats positioned directly behind other seats, monuments, walls, etc., and seats in other orientations relative to, for example, the forward end of the aircraft and/or the direction F of forward travel, such as side facing seats, or seats oriented at other angles relative to the longitudinal axis A of the aircraft.

The seating area 100 includes a structure 104 positioned forward of the seat 102. In the illustrated embodiment, the structure 104 is a monument (e.g., a dividing wall) positioned between the seat 102 and a second seat 103 that is positioned generally forward of the seat 102. Accordingly, the structure 104 can be at least partially separated from the second seat 103 such that reclining the second seat 103 does not change the position or angle of the structure 104 relative to a floor 105 of the seating area 100. In other embodiments, however, the structure 104 can be a seat back of the second seat 103, such as may be found in, for example, a coach passenger cabin. In such embodiments, the angle of the structure 104 relative to the floor 105 may be changed when the second seat 103 is reclined. As one of skill in the art will appreciate from the disclosure herein, in further embodiments the structure 104 can be any structure generally forward of seat 102, such as a cabin partition wall, a bulkhead, a galley wall, etc. In the illustrated embodiment, the structure 104 includes a video monitor 106. As one of skill in the art will appreciate, however, the video monitor 106 can be omitted without deviating from the scope of the present disclosure.

As illustrated in FIG. 1, an airbag enclosure or housing 131 can be positioned within or otherwise secured to the structure 104. In the illustrated embodiment, the housing 131 is positioned beneath the video monitor 106 and directly forward of the seat 102 along the seat center axis S. In other embodiments, the housing 131 can be slightly offset from the seat center axis S. As described in greater detail below, the housing 131 contains stowed airbag 120 that is configured to deploy through an opening in the housing 131 toward the seat 102 during a rapid deceleration or other crash event and lessen the crash impact experienced by the seat occupant 101 and/or prevent the occupant 101 from striking the structure 104. The housing 131 can further serve to conceal the airbag 120 from view of the seat occupant 101 and provide an aesthetically pleasing seating environment. In the illustrated embodiment, an upper boundary 131a of the housing 131 is spaced apart from the floor 105 by a height H₁. The height H₁ can vary depending on, for example, the height of the seat 102 relative to the floor 105 and the deployment angle of the airbag 120, as described in detail below.

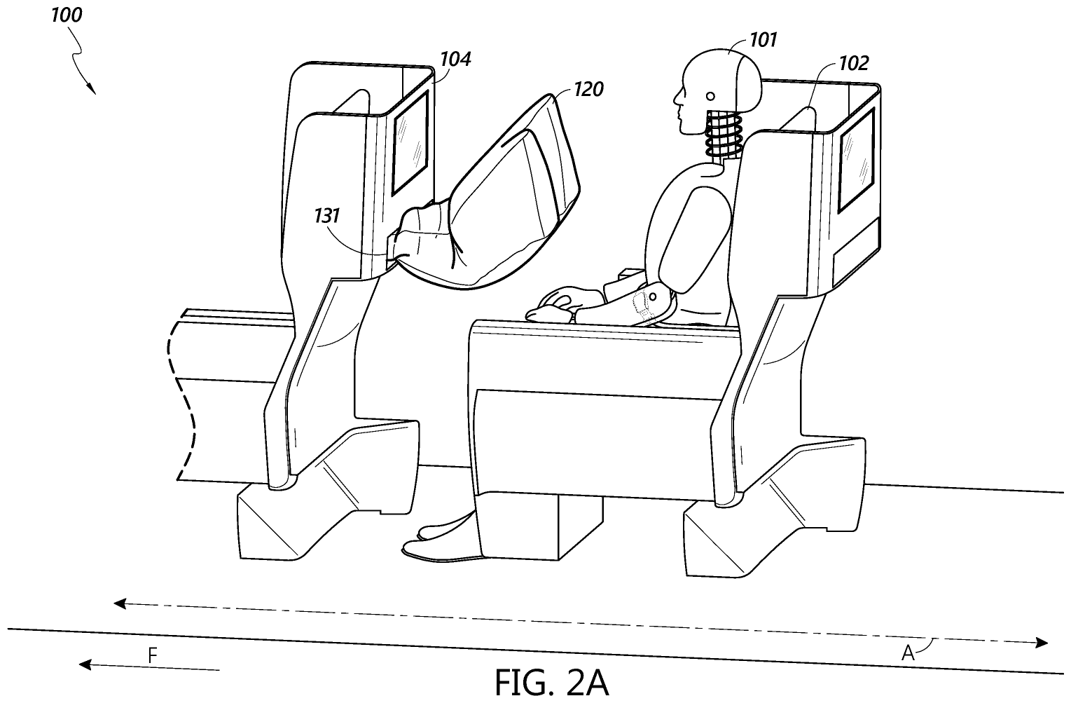

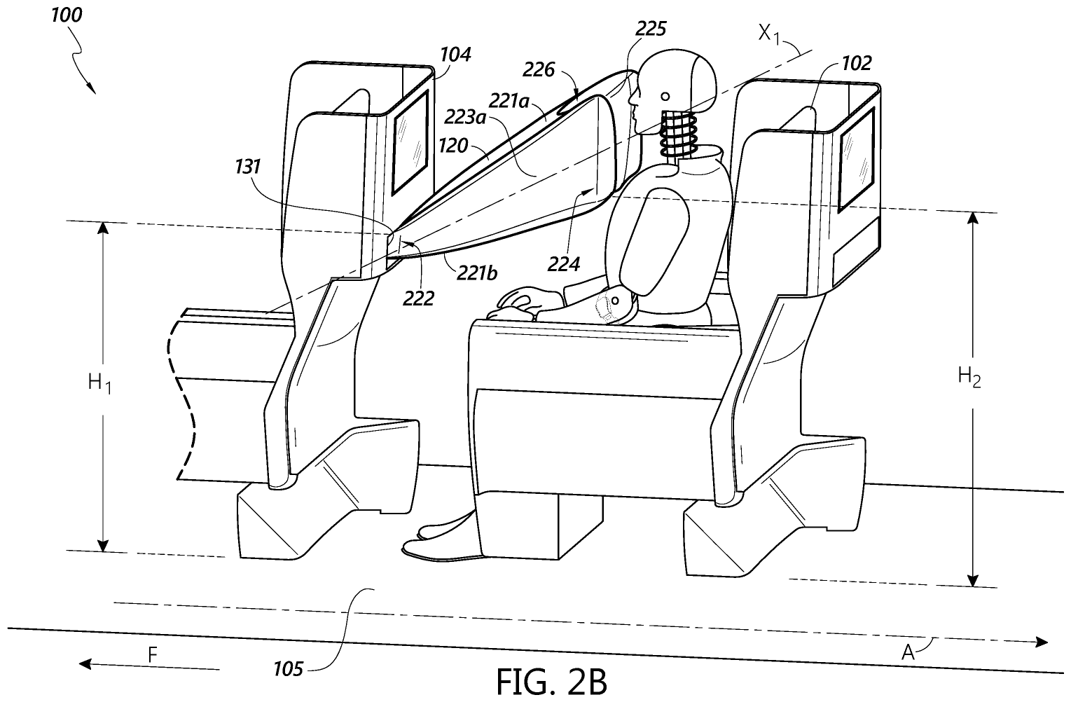

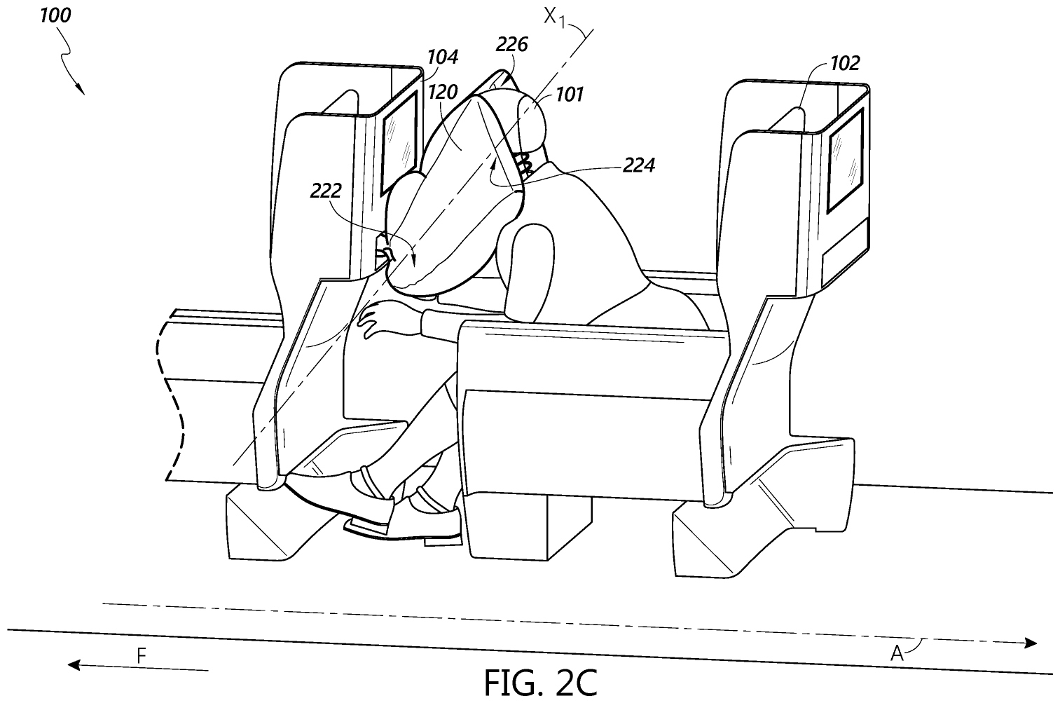

FIGS. 2A-2C are a series of isometric views of the seating area 100 illustrating deployment of the airbag 120 from the housing 131 in accordance with an embodiment of the present technology. More specifically, FIG. 2A illustrates the airbag 120 deploying from the housing 131 in a direction toward the occupant 101 in response to a dynamic event. In FIG. 2A, the airbag 120 is not yet fully inflated. FIG. 2B illustrates the airbag 120 in a fully inflated position with the occupant 101 beginning to move forward in direction F in response to the rapid deceleration forces created by the dynamic event. FIG. 2C illustrates the occupant 101 pitching further forward and contacting the airbag 120.

Referring to FIG. 2B, the airbag 120 includes a proximal end portion 222 adjacent to the housing 131 and a distal end portion 224 spaced apart from the housing 131 and toward the seat 102. The airbag 120 also includes an upper surface portion 221a, a lower surface portion 221b, a first side surface portion 223a, and a second side surface portion (not shown) opposite the first side surface portion 223a. In the fully inflated state shown, the airbag 120 extends at least partially upward with respect to the longitudinal axis A of the aircraft (e.g., at an upward angle relative to the cabin floor 105). More specifically, the airbag 120 has a longitudinal axis X₁ extending from the proximal end portion 222 to the distal end portion 224 at an upward angle relative to the longitudinal axis A. For example, in some embodiments, the longitudinal axis X₁ of the airbag 120 forms an acute angle of between about 5 degrees and about 85 degrees, or between about 10 degrees and about 45 degrees, relative to the longitudinal axis A.

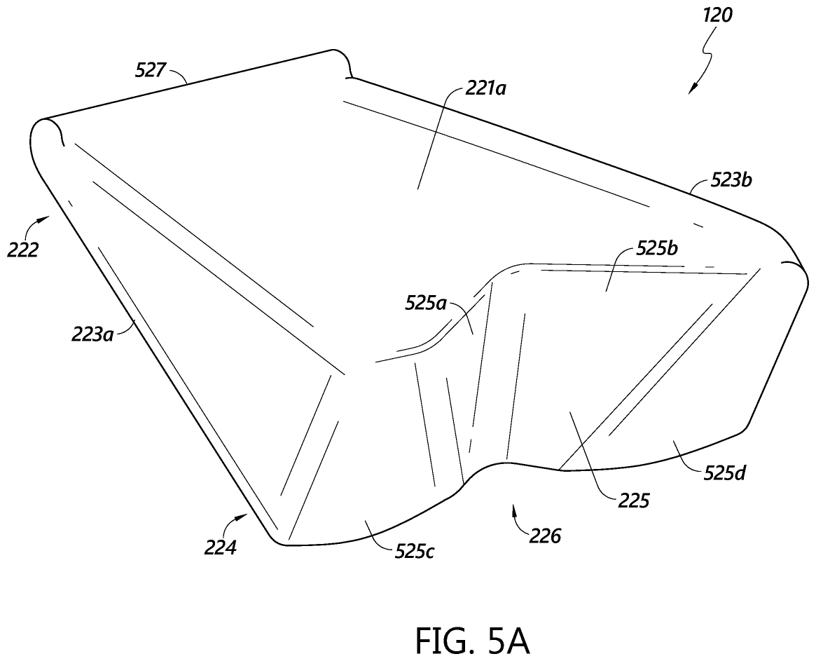

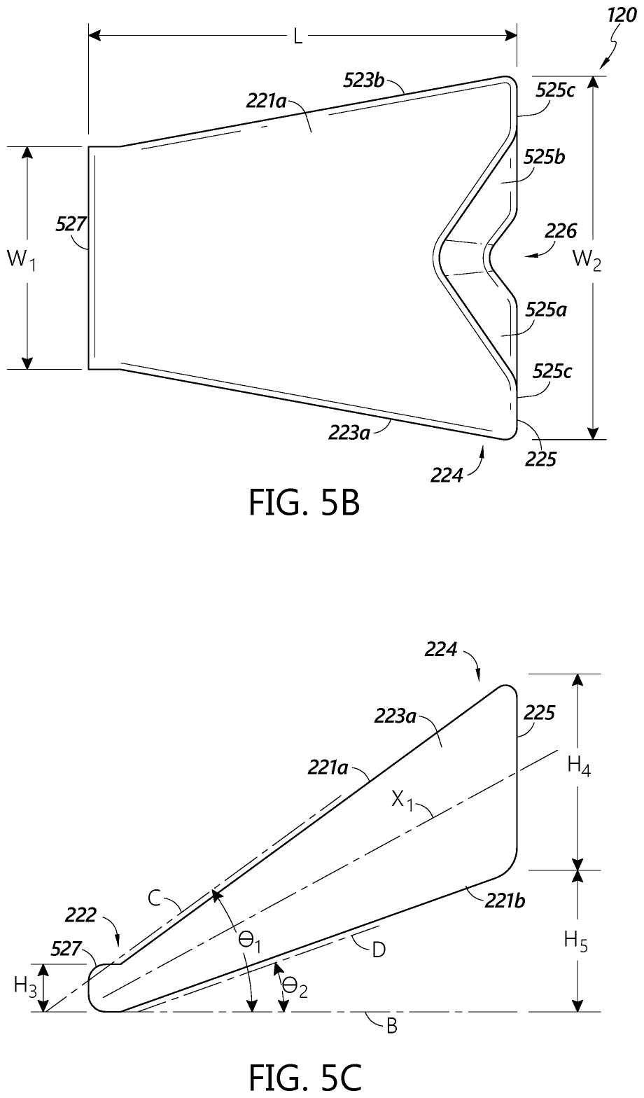

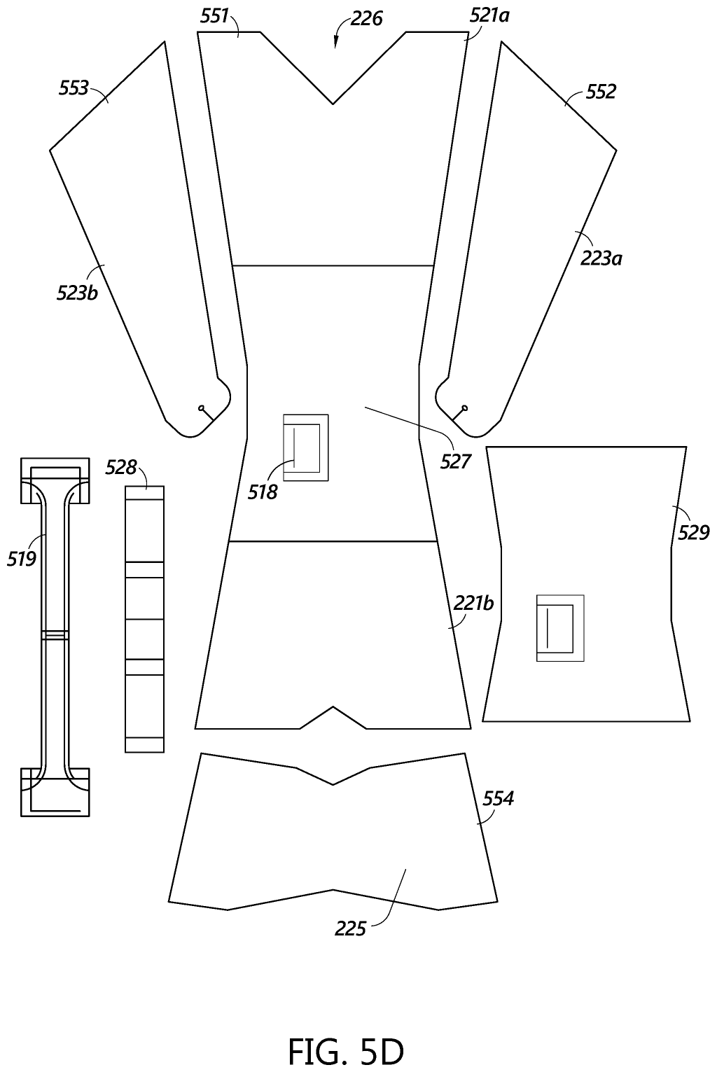

The distal end portion 224 of the airbag 120 includes an impact surface portion 225. As will be described in greater detail with respect to FIGS. 5A-5D, the impact surface portion 225 is shaped to define a recess 226 when the airbag 120 is inflated. During a dynamic event, the recess 226 receives at least a portion of the neck and/or head of the occupant 101, as best illustrated in FIG. 2C. The recess 226 is expected to reduce and or prevent significant rotation of the head of the occupant 101, even in embodiments where the seat 102 is not positioned in a forward direction (e.g., if the seat 102 is positioned at a non-zero angle relative to the longitudinal axis A of the aircraft). When the airbag 120 is fully inflated, the impact surface portion 225 is spaced apart from the cabin floor 105 by a height H₂. The height H₂ can vary depending on a number of factors, including the height H₁ of the housing 131 and the angle of the longitudinal axis X₁ relative to the longitudinal axis A of the aircraft. In some embodiments, the height H₂ can be greater than the height H₁.

Referring next to FIG. 2C, the airbag 120 bends or deflects upwards in response to the occupant 101 contacting the impact surface portion 225 during the dynamic event such that the longitudinal axis X₁ pivots or rotates upwardly about the proximal end portion 222. In this position, the longitudinal axis X₁ defines a greater angle relative to the longitudinal axis A than the angle defined prior to the occupant 101 contacting the impact surface portion 225. In some embodiments, the airbag 120 bends at the proximal end portion 222 as it deflects upwards. This can be at least partially due to the relatively smaller cross-sectional area of the proximal end portion 222 as compared to the cross-sectional area of the distal end portion 224. Because of the relatively smaller cross-sectional area of the proximal end portion 222, the airbag 120 can advantageously bend and/or rotate upwardly at the proximal end portion 222 in response to the occupant 101 contacting the airbag 120. The movement of the airbag 120 in this manner is expected to reduce the forward momentum and/or velocity of the occupant 101 while reducing and/or preventing injuries the occupant 101 might otherwise sustain in the absence of the airbag 120. For example, operation of the airbag 120 in this manner can prevent the occupant 101 from striking the structure 104. As a result, use of the airbag 120 can enable the seat 102 to be positioned closer to the structure 104 than would otherwise be possible, thereby allowing more seats to fit within a single aircraft.

The airbag 120 can optionally include a vent (e.g., a passive or active opening; not shown) that remains closed until the internal pressure of the airbag 120 reaches a predetermined threshold, such as when the seat occupant impacts the airbag 120 and/or when the airbag 120 is fully inflated. In some embodiments, the vent can be an elongated seam that tears or otherwise ruptures at the threshold pressure to release the gas (e.g., air) from within the airbag 120. In other embodiments, the vent can have other suitable configurations (e.g., a valve or plug), or it can be omitted. The vent prevents the pressure within the airbag from exceeding the predetermined threshold and reduces the tendency for the seat occupant 101 to rebound backward in response to compressing the inflated airbag 120. Additionally, the vent can quickly deflate the airbag 120 after the dynamic event to provide a substantially clear passageway for the occupant 101 to quickly move away from the seat 102.

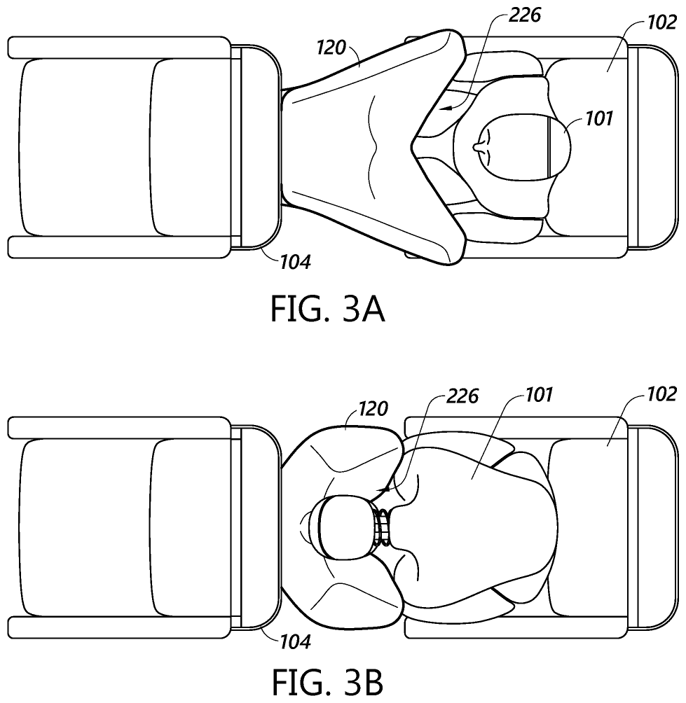

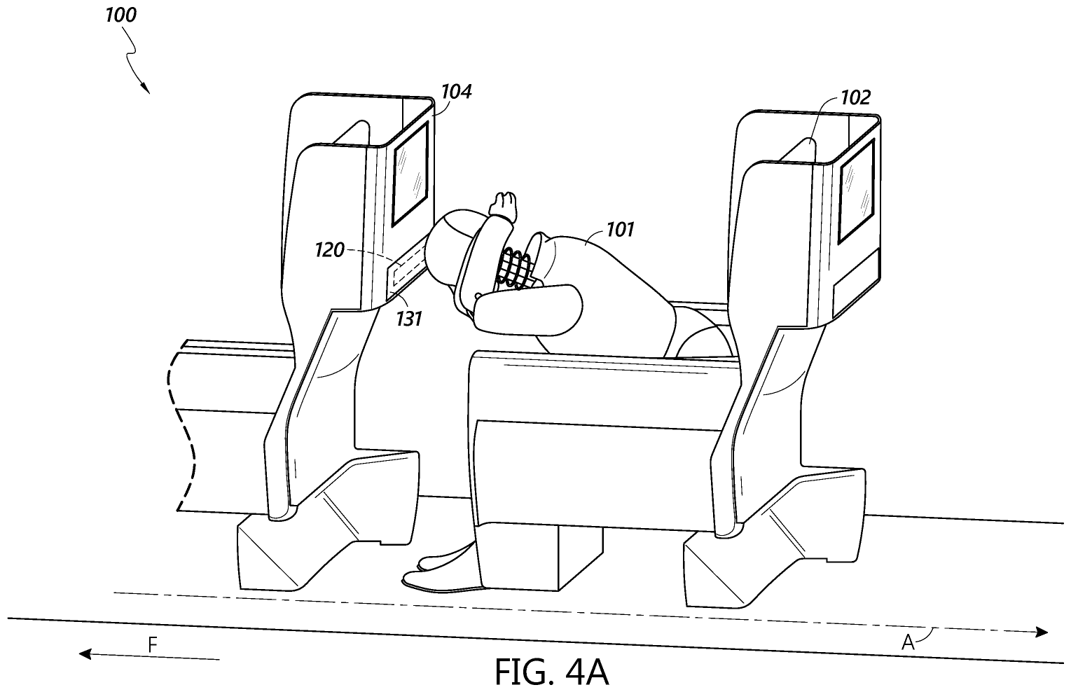

FIGS. 3A and 3B are top views of the seating area 100 that correspond to the isometric views depicted in FIGS. 2B and 2C, respectively. In FIG. 3A, the airbag 120 is fully inflated and the occupant 101 is beginning to move forward toward the structure 104 in response to the deceleration forces associated with the dynamic event. FIG. 3B depicts the seating area 100 after the occupant 101 has contacted the airbag 120. As described above, the recess 226 in the airbag 120 is configured to receive the occupant's head and/or neck regions and reduce the forward momentum and/or velocity of the occupant 101 to reduce and/or prevent injuries the occupant 101 may otherwise incur from striking the structure 104.

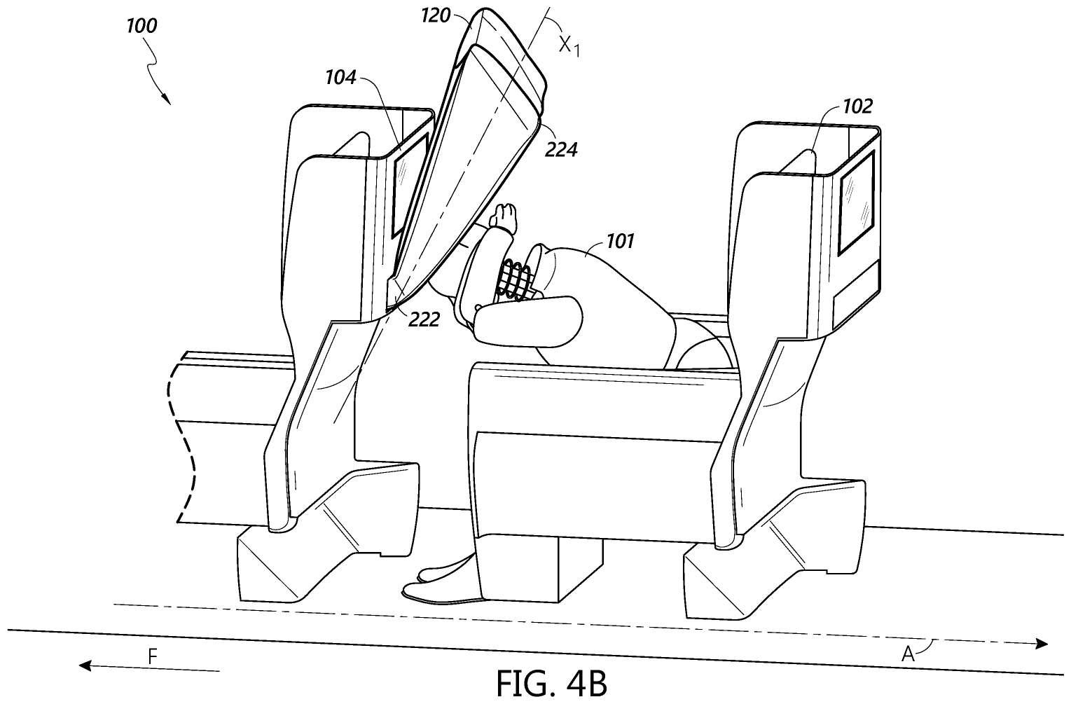

FIGS. 4A and 4B illustrate an additional advantage of some embodiments of the present technology. More specifically, FIG. 4A is an isometric side view of the seating area 100 in which the occupant 101 is seated a “brace” position. In the brace position, the occupant is bent forward at the waist such that the occupant's torso is generally parallel to the occupant's thighs. As one skilled in the art will appreciate, aircraft passengers are often instructed to assume the brace position in advance of an anticipated crash event. Traditionally, the brace position was expected to reduce injury to the passenger by minimizing a distance between the occupant's head and the object the occupant's head is most likely to strike (e.g., structure 104). However, use of airbags can potentially raise issues for occupants in the brace position. For example, a conventional airbag may deploy directly against the head of an occupant in the brace position, potentially causing injury. As described below with respect to FIG. 4B, the present technology is expected to reduce this risk.

FIG. 4B is a side view of the seating area 100 with the occupant 101 in the brace position after the airbag 120 has deployed. As illustrated, the airbag 120 deflects upwardly upon contacting the occupant's head instead of inflating against the top of the occupant's head. The airbag 120 can deflect upwardly due in part to a number of factors. First, the airbag 120 is configured to deploy at an upward angle relative to the longitudinal axis A of the aircraft, as described above. This upward deployment may cause the airbag 120 to either miss the occupant 101 and/or deflect upwardly upon contacting a portion of the occupant 101 (e.g., the occupant's head). Second, as described above with reference to FIG. 2B, the airbag 120 has an outwardly tapered shape such that the proximal end portion 222 has a smaller cross-sectional area than the distal end portion 224. This feature enables the airbag 120 to bend and deflect at the proximal end portion 222 in response to the distal end portion 224 contacting the occupant's head in the brace position. In the illustrated embodiment, the airbag 120 is both deflected upwardly and bending at the proximal end portion 222 such that the longitudinal axis X₁ has a greater slope or angle relative to the longitudinal axis A than the configuration of the airbag 120 shown in FIGS. 2B and 2C.

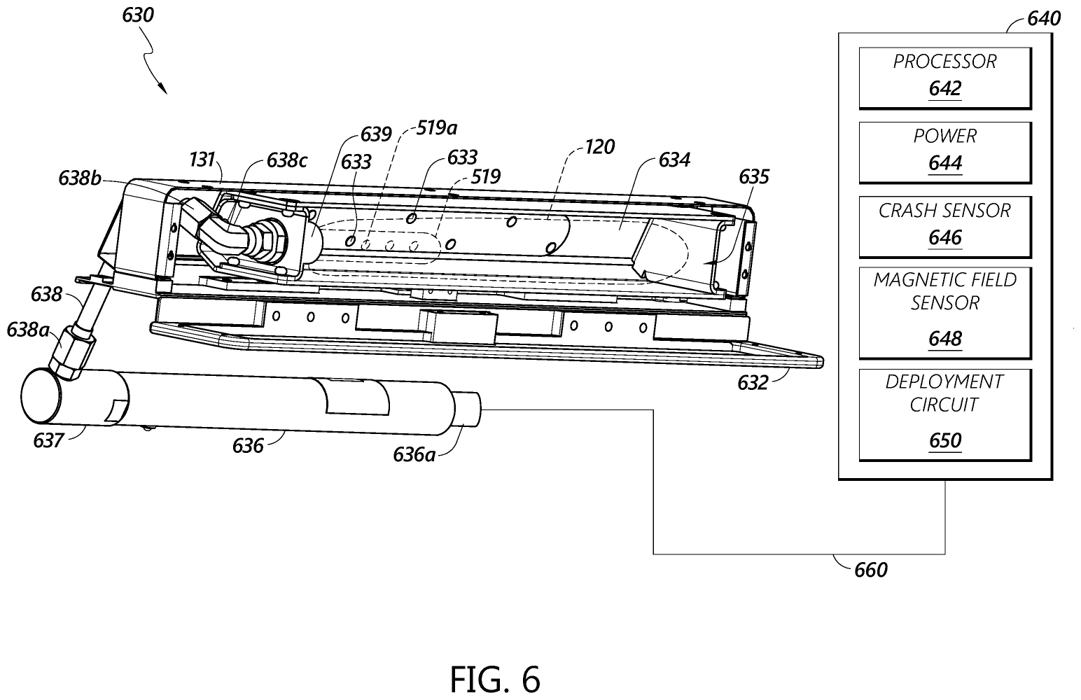

FIGS. 5A-5D are a series of isometric, top, side, and flat panel views, respectively, of the airbag 120 configured in accordance with an embodiment of the present technology. Referring first to FIGS. 5A and 5B, the airbag 120 is illustrated in an inflated state and includes an attachment portion 527 at the proximal end portion 222. The attachment portion 527 can be configured to attach the airbag 120 to the housing 131 (FIGS. 1 and 6). As described above with reference to FIG. 2B, the airbag 120 includes the upper surface portion 221a, the lower surface portion 221b, the first side surface portion 223a, and a second side surface portion 523b. When deployed, the upper surface portion 221a faces generally upward (e.g., toward a ceiling of an aircraft cabin) and the lower surface portion 221b faces generally downward (e.g., toward the floor 105 of the aircraft cabin). In the illustrated embodiment, the airbag 120 has a general wedge shape, although other shapes, including other outwardly tapered shapes, funnel shapes, cylindrical shapes, conical shapes, and the like, are also suitable. In some embodiments, the airbag 120 includes a single inflatable chamber.

As described above with reference to FIGS. 2A-2C, the impact surface portion 225 is configured to receive the head and/or neck of a seat occupant when the airbag is deployed. In the illustrated embodiment, the impact surface portion 225 is shaped to define the recess 226 when the airbag is fully inflated. Specifically, in some embodiments the impact surface portion 225 includes a first angled surface portion 525a and a second angled surface portion 525b. The first angled surface portion 525a and the second angled surface portion 525b can be angled inwardly toward the proximal end portion 222 of the airbag 120, thereby forming the “V-shaped” recess 226. In the embodiment illustrated, the first angled surface portion 525a is at least slightly spaced apart from the first side surface portion 223a by a first edge portion 525c of the impact surface portion 225, and the second angled surface portion 525b is at least slightly spaced apart from the second side surface portion 523b by a second edge portion 525d of the impact surface portion 225. In other embodiments, the first angled surface portion 525a can extend from proximate the first side surface portion 223a and the second angled surface portion 525b can extend from proximate the second side surface portion 523b. In the illustrated embodiment, the recess 226 defines a generally “V-shaped” notch. In other embodiments, the recess 226 can have configurations, such as a half-cylinder or “U-shaped” notch. In embodiments where the airbag 120 includes a single inflatable chamber, the recess 226 can be wholly formed by the single inflatable chamber.

The airbag 120 can have a length L, a width W₁ at the proximal end portion 222, and a width W₂ at the distal end portion 224. The length L can be between about 10 inches and about 40 inches, between about 15 inches and about 30 inches, or about 22 inches. As one skilled in the art will appreciate, the length L of the airbag 120 can be selected based on a number of factors, including the distance between the seat occupant and the forward strike hazard. The width W₁ is generally equal to or less than the width W₂, although in some embodiments the proximal width W₁ can be greater than the distal width W₂. For example, the width W₁ can be between about 5 inches and about 20 inches, between about 10 inches and about 15 inches, or about 12 inches. The width W₂ can be between about 5 inches and about 30 inches, between about 10 inches and about 25 inches, or about 20 inches.

FIG. 5C is a side view of the airbag 120 in an inflated state and illustrates additional features of airbag 120. For example, the upper surface portion 221a extends generally parallel to plane C and the lower surface portion 221b extends generally parallel to plane D. In the illustrated embodiment, both the plane C and the plane D are angled upwardly relative to a reference plane B that extends parallel to the longitudinal axis A of the aircraft when the airbag 120 is deployed. For example, the plane C of the upper surface portion 221a can form a first angle θ₁ relative to the reference plane B, and the plane D of the lower surface portion 221b can form a second angle θ₂ relative to the reference plane B. In the illustrated embodiment, the first angle θ₁ is greater than the second angle θ₂ and the upper surface portion 221a is not parallel to the lower surface portion 221b. In other embodiments, the first angle θ₁ can be the same or substantially the same as the second angle θ₂. Accordingly, in other embodiments the upper surface portion 221a can be parallel or substantially parallel to lower surface portion 221b. In some embodiments, the impact surface portion 225 can be generally perpendicular to plane B.

As described above, the longitudinal axis X₁ of the airbag extends at a generally upward angle relative to the reference plane B. The upward angle of the longitudinal axis X₁ is typically between the first angle θ₁ and the second angle θ₂. However, in embodiments in which the first angle θ₁ and the second angle θ₂ are equal or substantially equal, the longitudinal axis X₁ can form an angle with plane B that is the same as the first angle θ₁ and the second angle θ₂. In some embodiments, the longitudinal axis X₁ and the reference plane B form an acute angle between about 5 degrees and about 85 degrees, such as, for example, about 5 degrees and about 85 degrees, between about 10 degrees and about 55 degrees, between about 15 degrees and about 45 degrees, or about 30 degrees.

The attachment portion 527 can have a first height H₃ and the impact surface portion 225 can have a second height H₄. For example, the first height H₃ can be about 10 inches or less, about 5 inches or less, or about 3 inches. The second height H₄ can be between about 5 inches and about 20 inches, between about 10 inches and about 15 inches, or about 10 inches. The second height H₄ can be selected such that when the occupant initially contacts the impact surface portion 225 during airbag deployment (FIGS. 2B and 2C), the impact surface portion 225 receives and contacts substantially all of the front portion of the occupant's neck and/or the occupant's face. In the illustrated embodiment, the airbag 120 is generally tapered such that the cross-sectional height of the airbag increases moving from the proximal end portion 222 toward the distal end portion 224 (e.g., between H₃ and H₄). For example, in the illustrated embodiment, a first cross-section taken at the proximal end portion 222 has a first cross-sectional height and a second cross-section taken at the distal end portion 224 has a second cross-section height that is greater than the first cross-sectional height. Likewise, a third cross-section taken at a medial portion of the airbag 120 between the proximal end portion 222 and the distal end portion 224 has a third cross-sectional height that is greater than the first cross-sectional height and less than the second cross-sectional height. As described above, the airbag 120 also deploys at a generally upward angle relative to plane B. Accordingly, the distal end portion 224 can be spaced by a third height H₅ above the reference plane B. For example, the third height H₅ can be between about 1 inch and about 20 inches, between about 5 inches and about 15 inches, or about 7 inches. As one skilled in the art will appreciate, the dimensions of the airbags configured in accordance with the present technology can be selected according to the dimensions of the seating area the airbag will be used in as well as other factors. Accordingly, airbags configured in accordance with the present technology are not limited to the dimensions described above.

FIG. 5D is a flat panel view of the airbag 120. As illustrated, the airbag 120 can comprise multiple individual panels or sheets of suitable material, such as silicone coated nylon fabric (e.g., 315 denier silicone coated woven nylon fabric), that can be sewn, stitched, banded, or otherwise coupled together using methods well known in the art to form the airbag 120. For example, a first panel 551 can form the upper surface portion 221a, the attachment portion 527, and the lower surface portion 221b. The first panel 551 is illustrated as a single panel, but can alternatively be formed from multiple panels sewn or otherwise attached using methods known in the art. A second panel 552 can form the first side surface portion 223a, a third panel 553 can form the second side surface portion 523b, and a fourth panel 554 can form the impact surface portion 225. The airbag 120 can also include a reinforcement panel 529. The reinforcement panel 529 can be secured to the first panel 551 to provide additional structural integrity to the airbag 120 and/or provide variable stiffness along the length of the airbag 120. The airbag 120 can also include a tether 528 for connecting the upper surface portion 221a and the lower surface portion 221b to maintain a desired shape of the airbag 220 when fully inflated. The airbag 120 can also include a fabric hose or tube 519 that can be coupled to a gas hose that is in fluid connection with the interior of the airbag, as described in greater detail below with reference to FIG. 6. In the illustrated embodiment, the attachment portion 527 includes a slit 518 through which the fabric tube 519 extends into the interior of the airbag 120. The fabric tube 519 can be sewn or otherwise attached to an interior surface of the airbag 120 and deliver gases thereto to inflate the airbag 120. In other embodiments, airbags configured in accordance with the present disclosure can be constructed using other materials and other suitable construction techniques.

FIG. 6 is a partially schematic isometric view of an airbag assembly 630 configured in accordance with some embodiments of the present technology. The airbag assembly 630 includes the housing 131 and an inflator 636 operably coupled in fluid communication to an inlet fitting 639 of the housing 131 by a hose 638. The inflator 636 can be electronically connected to an electronics module assembly 640 (shown schematically) by an electrical link 660. The hose 638 can be connected to the inflator 636 by a first hose fitting 638a and to the inlet fitting 639 by a second hose fitting 638b. In some embodiments, an elbow fitting 638c connects the second hose fitting 638b and the inlet fitting 639. The inlet fitting 639 is coupled in fluid communication to the fabric tube 519, which is positioned within the airbag 120 in the housing 131. The fabric tube 519 can include a plurality of apertures 519a for releasing gases into the airbag 120. In other embodiments, the hose 638 can be integral with or otherwise fluidly coupled to the fabric tube 519. The airbag 120 can be stowed within the housing 131 in a chamber 634 and configured to deploy through an opening 635 upon detection of a dynamic event above a preset threshold. The proximal end portion of the airbag 120 can be secured to the housing 131 using any suitable method. For example, in the illustrated embodiment, the housing 131 includes a plurality of apertures 633 that can receive threaded studs (not shown) that extend from an aluminum plate positioned in the airbag adjacent the proximal end portion. The studs can pass through the plurality of apertures 633 and releasably engage the apertures 633 and/or the adjacent structure 104 (FIG. 1) to retain the airbag 120 to the housing 131.

The housing 131 includes a door hingeably or otherwise coupled to the housing 131 and moveable between a “closed” position and an “open” position (shown). When the door 632 is in the closed position, the chamber 634 is at least substantially concealed and the airbag 120 is hidden from view of a seat occupant (see, e.g., FIG. 1). When the door 632 is in the open position, the airbag 120 can deploy outwardly from the housing 131. The door 632 can be attached to the housing 131 using one or more releasable fasteners that swing or otherwise enable the door 632 to open under the force of the inflating airbag, thereby allowing the airbag 120 to deploy from the chamber 634. The door 632, for example, can be secured in the closed position with a plurality of “frangible” screws that are configured to break under the force of airbag deployment. In other embodiments, the door 632 can be configured to automatically open in response to a crash event rather than relying on the deployment force of the airbag 120. The door 632, for example, can include electronics to automatically slide, pivot, and/or otherwise open in anticipation of airbag deployment.

The inflator 636 is operably coupled in fluid communication with the airbag 120 stowed within the chamber 634. In some embodiments, the inflator 636 can include a stored gas canister that contains compressed gas (e.g., compressed air, nitrogen, argon, helium, etc.) at high pressure. The inflator 636 can include an initiator 636a (e.g., a pyrotechnic device, such as a squib) and a coupling 637 that attaches the inflator 636 to the hose 638. In other embodiments, other suitable inflator devices can be used without departing from the scope of the present disclosure. Such devices can include, for example, gas generator devices that generate high pressure gas through a rapid chemical reaction of an energetic propellant, hybrid inflators, etc. Accordingly, airbag assemblies configured in accordance with the present technology are not limited to a particular type of airbag inflation device. In some embodiments, the inflator 636 can be spaced apart from the housing 131 and operably coupled thereto using the hose 638 and/or another suitable fluid passageway. Accordingly, when a rapid deceleration or other dynamic event above a preset magnitude (e.g., 15 g's) is detected, the hose 638 directs high pressure gas from the inflator 636 to the airbag 120 to inflate and deploy the airbag 120.

In the illustrated embodiment, the electronics module assembly 640 includes a processor 642 that receives electrical power from a power source 644 (e.g., one or more batteries, such as lithium batteries), a deployment circuit 650 that initiates the inflator 636, and at least one crash sensor 646 (e.g., an accelerometer) that detects rapid decelerations and/or other dynamic events greater than a preset or predetermined magnitude. The processor 642 can include, for example, suitable processing devices for executing instructions on computer-readable media. The crash sensor 646 can, for example, include a spring-mass damper type sensor with an inertial switch calibrated for the vehicle's operating environments that initiates airbag deployment upon a predetermined level of deceleration. In other embodiments, the crash sensor 646 can include other types of sensors known in the art and/or other additional features to facilitate airbag deployment. Optionally, the electronics module assembly 640 can also include one or more magnetic field sensors 648 that detect the presence of an external magnetic field (e.g., from a speaker) and communicate with the processor 642 to deactivate the crash sensor 646 and prevent inadvertent deployment of the airbag. The magnetic field sensor 648 can include, for example, the circuitry disclosed in U.S. Pat. No. 6,535,115, entitled “AIR BAG HAVING EXCESSIVE EXTERNAL MAGNETIC FIELD PROTECTION CIRCUITRY,” which is herein incorporated by reference in its entirety. In other embodiments, the electronics module assembly 640 can include other sensors and/or additional features to aid in airbag deployment, and/or some of the components of the electronics module assembly 640 may be omitted. In certain embodiments, for example, the electronics module assembly 640 can include only the power source 644 and the crash sensor 646, which completes a circuit to activate the inflator 636 during a crash event. The components of the electronics module assembly 640 can be housed in a protective cover (e.g., a machined or injection-molded plastic box) that can reduce the likelihood of damaging the electronics module assembly 640 and a magnetic shield that can prevent the electronics module assembly 640 from inadvertently deploying the airbag.

The electronics module assembly 640 can be electrically coupled to the inflator 636 via at least one electrical link 660 (e.g., a wire). In a dynamic event above a predetermined threshold (e.g., a rapid deceleration of a certain magnitude resulting from the aircraft experiencing a collision or other significant dynamic event), the crash sensor 646 can detect the event and respond by sending a signal to the processor 642 which causes the processor 642 to send a corresponding signal to the deployment circuit 650. The deployment circuit 650 applies a voltage to the inflator 636 via the electrical link 660 sufficient to activate the inflator 636, which opens or otherwise causes the inflator 636 to rapidly discharge its compressed gas into the airbag via the hose 638 in a known manner. The rapid expansion of the compressed gas flowing into the airbag causes the airbag 120 to rapidly expand and deploy from the chamber 634 (e.g., in about 40-55 milliseconds). In some embodiments, the airbag 120 is deployed and fully inflated in less than about 100 milliseconds (e.g., about 90 milliseconds, about 80 milliseconds, etc.) following detection of a dynamic event. The airbag deployment and inflation systems described above are provided by way of example of such suitable systems. It should be noted, however, that the various embodiments of the airbags described herein are not limited to use with the particular inflation systems described above, but can also be used with other types of inflation systems without departing from the present disclosure.

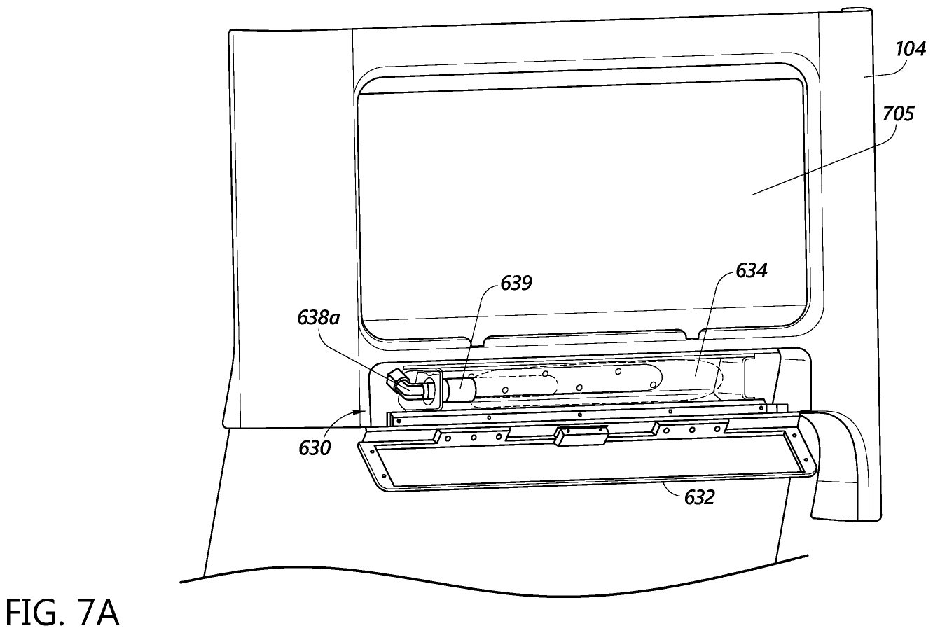

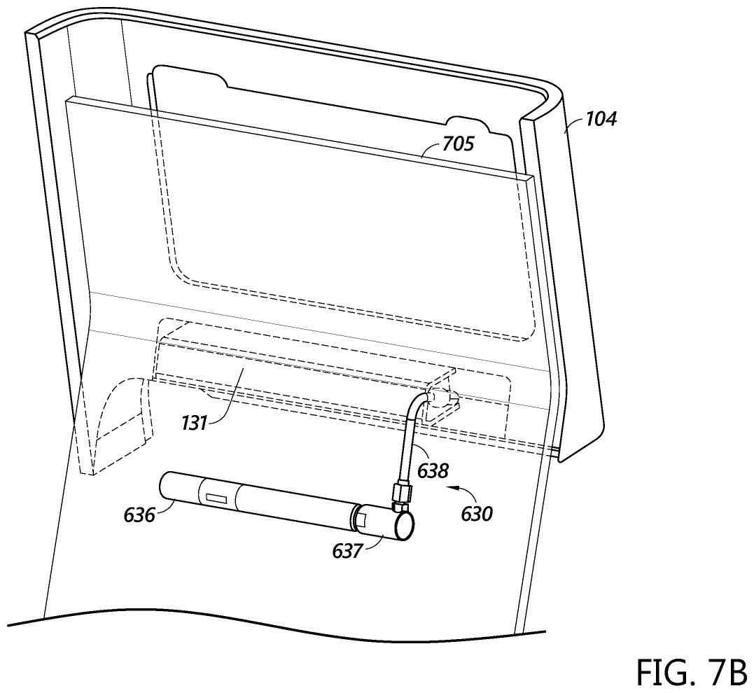

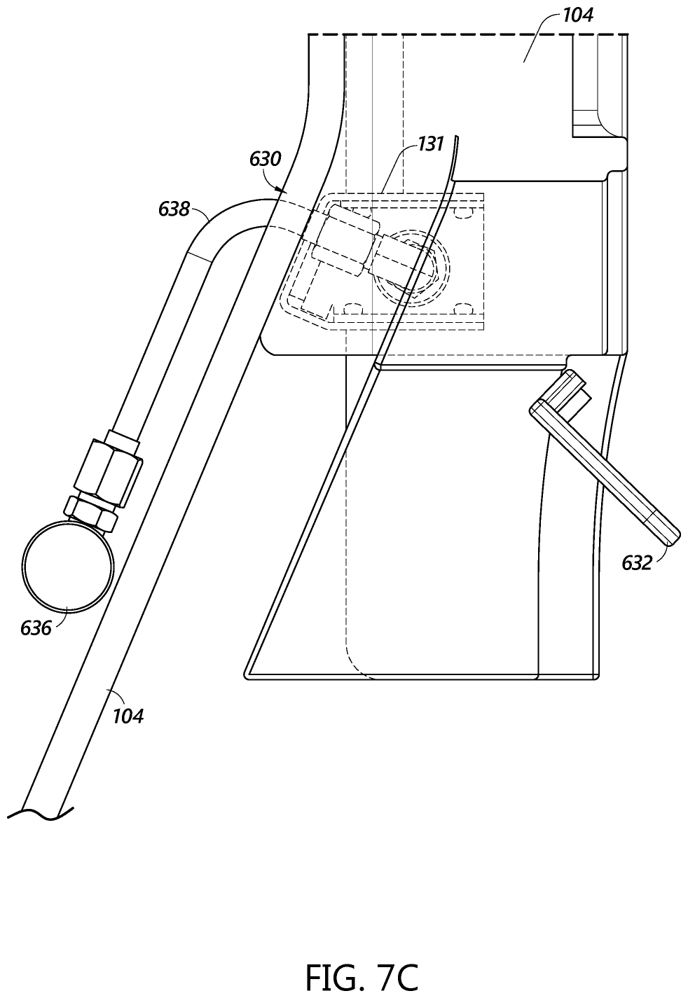

FIGS. 7A-7C are front-isometric, rear-isometric, and side views, respectively, of the airbag assembly 630 positioned within the structure 104. In some embodiments, the airbag assembly 630 is substantially and/or entirely disposed within the structure 104. For example, the airbag assembly 630 can be substantially and/or entirely out of view of seat occupants. Referring to FIG. 7A, in the illustrated embodiment the housing 131 is positioned beneath a video monitor mounting structure 705, which can be used to mount video monitor 106 (FIG. 1). In the illustrated embodiment, the door 632 is in the open position, although when installed in the aircraft the door 632 can be in the closed position. In some embodiments, when the door 632 is in the closed positioned, the exterior facing portion of the housing 131 (e.g., the door 632) is substantially flush with the exterior facing surface of the structure 104. In other embodiments, the exterior facing portion of the housing 131 is slightly indented or otherwise offset from the exterior facing surface of the structure 104. Referring to FIGS. 7B and 7C, the inflator 636 and the hose 638 are positioned on or within a portion of the structure 104 and substantially and/or entirely out of view of the seat occupant. For example, the inflator 636 and the hose 638 may be positioned within an interior portion of structure 104 between the seat 103 (FIG. 1) and the rearward facing surface of the structure 104.

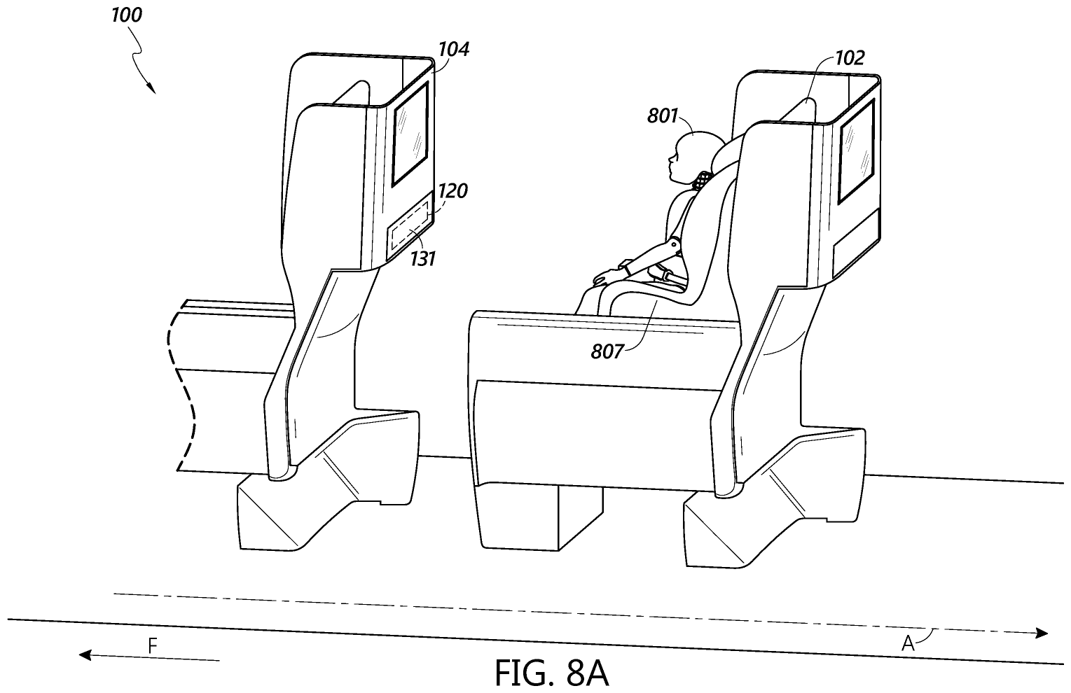

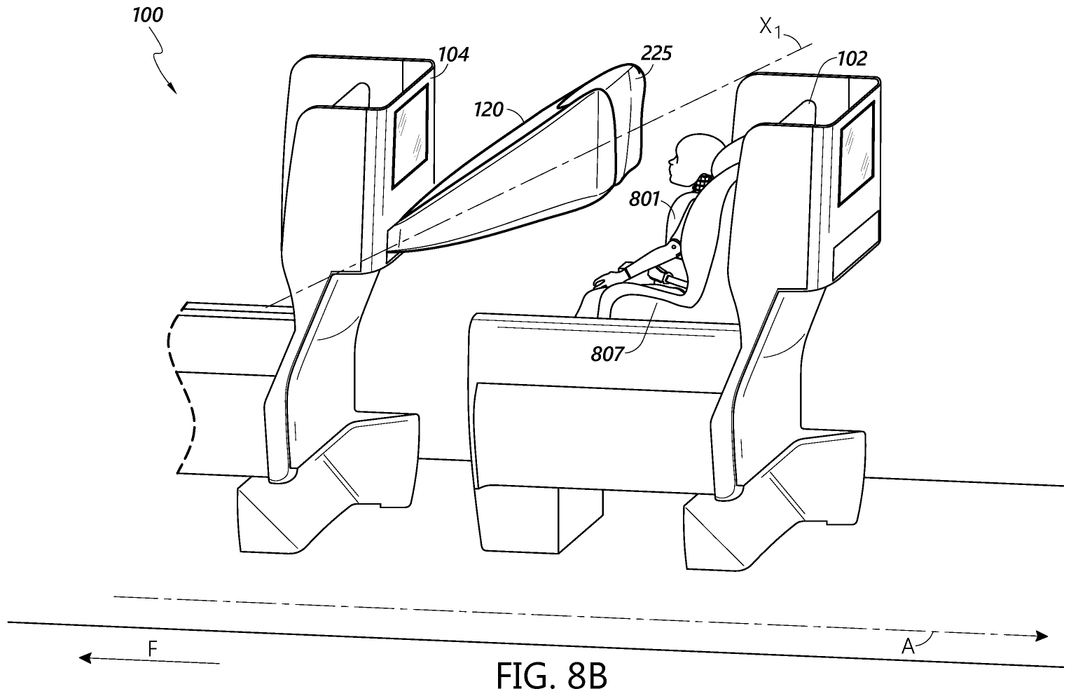

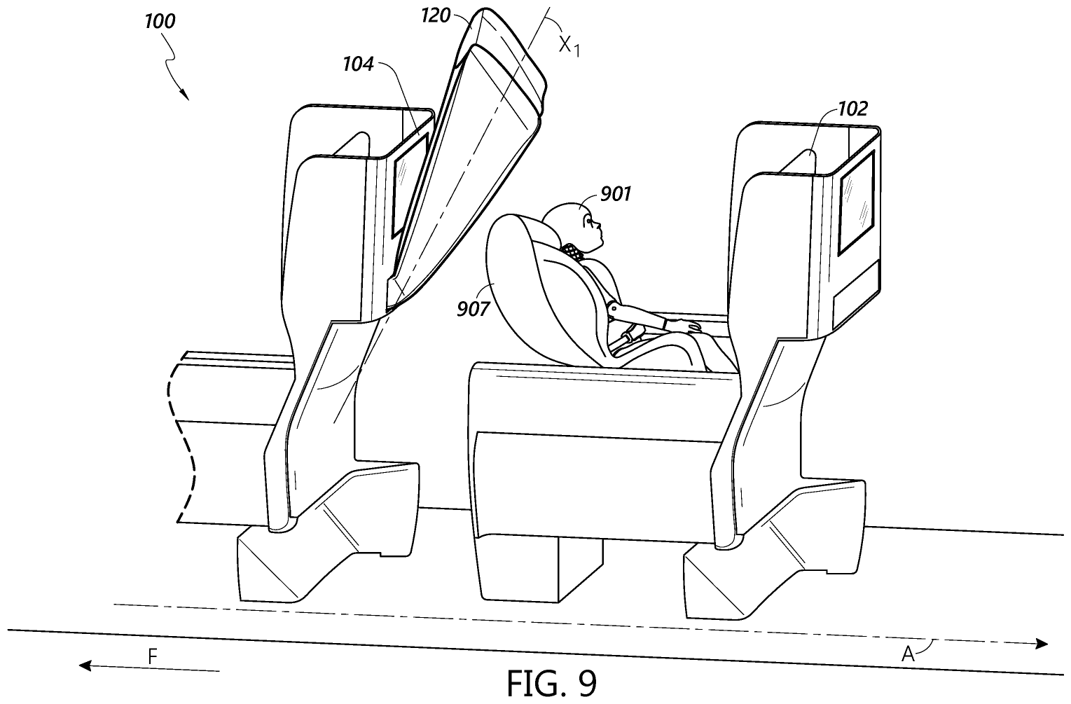

FIG. 8A is an isometric side view of the seating area 100 in which the seat occupant is a small child 801 seated in a child seat 807 in a forward orientation (e.g., facing towards the direction of travel F). The child seat 807 can be secured to the seat 102 using a seatbelt or other suitable attachment mechanism known in the art. FIG. 8B is an isometric side view of the seating area 100 of FIG. 8A immediately after the airbag 120 has deployed and is fully inflated. As this view illustrates, when the airbag 120 is fully inflated, it avoids striking the child 801 seated in the child seat 807 with substantial force. For example, the impact surface portion 225 of the airbag 120 can remain spaced apart from the child 801, even when the airbag 120 is fully inflated, thereby avoiding potential injury to the child 801.

FIG. 9 is an isometric side view of the seating area 100 in which the seat occupant is a small child 901 seated in a child seat 907 in a rearward orientation (e.g., facing opposite the direction of travel F). The child seat 907 can be secured to the seat 102 using a seatbelt or other suitable attachment mechanism known in the art. When deployed, the airbag 120 can bend and/or deflect upwardly upon striking the child seat 907, which can avoid imparting substantial forces on the child seat 907 and, therefore, avoid imparting substantial forces on the child 901 in the child seat 907. The airbag bends and/or deflects upwardly due to a number of factors, such as those described above with reference to FIG. 4.

Various airbag systems and associated components are described in U.S. Pat. Nos. 5,984,350; 6,439,600; 6,505,854; 6,505,890; 6,535,115; 6,217,066; 6,957,828; 7,665,761; 7,980,590; 8,403,361; 8,439,398; 8,469,397; 8,523,220; 8,556,293; 8,818,759; 8,914,188; 9,156,558; 9,176,202; 9,153,080, 9,352,839; 9,511,866; 9,889,937; 9,925,950; 9,944,245; and 10,391,960; in U.S. Patent Publication Nos.: 2012/0326422; 2016/0052636; 2018/0201375; 2019/0315470; in U.S. patent application Ser. Nos. 16/292,222; 16/351,140; 16/358,354; and Ser. No. 16/453,210; and in U.S. Provisional Patent Application No. 62/495,602, each of which is incorporated herein by reference in its entirety. Indeed, any patents, patent applications and other references identified herein are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the disclosure. The upper and lower limits of these smaller ranges may independently be included or excluded in the range, and each range where either, neither or both limits are included in the smaller ranges is also encompassed within the disclosure, subject to any specifically excluded limit in the stated range. Where the stated range includes one or both of the limits, ranges excluding either or both of those included limits are also included in the disclosure.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. An airbag system for use with an aircraft seat, the airbag system comprising:
a housing configured to be mounted forward of the seat, the housing having an opening;
an airbag stowed within the housing; and
an inflator in fluid communication with the airbag, wherein the inflator is configured to inflate the airbag in response to a dynamic event, whereby the airbag deploys through the opening to a fully inflated state in which the airbag includes—
a proximal end portion positioned adjacent to the housing and having a first cross-sectional height,
a distal end portion spaced apart from the housing and having a second cross-sectional height greater than the first cross-sectional height, and
a longitudinal axis extending from the proximal end portion to the distal end portion at an upward angle relative to a longitudinal axis of the aircraft.

2. The airbag system of claim 1 wherein, in the fully inflated state, the distal end portion defines a recess.

3. The airbag system of claim 2 wherein the recess is generally V-shaped.

4. The airbag system of claim 2 wherein the recess is configured to receive the head and/or neck of a seat occupant during the dynamic event.

5. The airbag system of claim 1 wherein, in the fully inflated state, the airbag further includes:
an upper surface portion extending between the proximal end portion and the distal end portion at a first upward angle relative to the longitudinal axis of the aircraft, and
a lower surface portion extending between the proximal end portion and the distal end portion at a second upward angle relative to the longitudinal axis of the aircraft, wherein the first upward angle is greater than the second upward angle.

6. The airbag system of claim 1 wherein the airbag system is positioned within an aircraft seating area having a floor, and wherein the opening of the housing includes an upper boundary spaced apart from the floor by a first height, and wherein, in the fully inflated state, the airbag further includes:
a lower surface portion extending from the proximal end portion to the distal end portion at an upward angle relative to the longitudinal axis of the aircraft, wherein a region of the lower surface portion proximate the distal end portion is spaced apart from the floor by a second height that is greater than the first height.

7. The airbag system of claim 1 wherein, in the fully inflated state, the airbag defines an outwardly tapering wedge shape.

8. The airbag system of claim 1 wherein the deployed airbag is configured to bend upwardly relative to the structure in response to the airbag contacting a seat occupant during the dynamic event.

9. The airbag system of claim 1 wherein the housing is carried by a structure positioned forward of the first seat.

10. The airbag system of claim 1 wherein the housing is mounted directly forward of the seat.

11. An airbag system for use with an aircraft, the airbag system comprising:
an airbag assembly configured to be mounted to a structure forward of an aircraft seat, wherein the airbag assembly includes an airbag having—
a proximal end portion,
a distal end portion,
an upper surface portion extending between the proximal end portion and the distal end portion,
a lower surface portion extending between the proximal end portion and the distal end portion, and
an impact surface portion extending between the upper surface portion and the lower surface portion proximate the distal end portion,
wherein, when the airbag is in a fully inflated state, (a) the proximal end portion is positioned adjacent to the structure, (b) the distal end portion is spaced apart from the structure, (c) a longitudinal axis of the airbag extends at an upward angle such that the proximal end portion is positioned at a first height relative to the aircraft seat and the impact surface portion is positioned at a second height, greater than the first height, relative to the seat, and (d) the impact surface portion defines a recess configured to receive a portion of a seat occupant during a dynamic event.

12. The airbag system of claim 11 wherein the recess is configured to receive the head and/or neck of the seat occupant during the dynamic event.

13. The airbag system of claim 11 wherein the recess is generally V-shaped.

14. The airbag system of claim 11 wherein the airbag is configured to avoid contacting the seat occupant's torso when the airbag is deployed.

15. The airbag system of claim 11 wherein, in the fully inflated state, the airbag defines an outwardly tapering wedge shape.

16. The airbag system of claim 11 wherein the deployed airbag is configured to bend upwardly relative to the structure in response to the seat occupant contacting the airbag during the dynamic event.

17. The airbag system of claim 11 wherein the airbag includes a single inflatable chamber, and wherein the recess is wholly formed by the single inflatable chamber.

18. An airbag system for use with an aircraft seat, the airbag system comprising:
an airbag assembly mountable to a structure forward of the aircraft seat, wherein the airbag assembly includes—
a housing; and
an airbag stored within the housing, wherein the airbag is configured to deploy upwardly in response to a dynamic event to receive the head and/or neck of an occupant seated behind the housing, and wherein the airbag is configured to deflect further upwardly in response to the occupant contacting the airbag during the dynamic event.

19. The airbag system of claim 18 wherein the airbag, when deployed, has:
a proximal end portion adjacent the housing;
a distal end portion spaced apart from the housing;
a first surface portion extending between the proximal end portion and the distal end portion and generally facing a ceiling of the aircraft; and
a second surface portion extending between the proximal end portion and the distal end portion and generally facing a floor of the aircraft,
wherein the first surface portion is non parallel to the second surface portion, and
wherein the first surface portion and the second surface portion extend at an upward angle relative to a longitudinal axis of the aircraft.

20. The airbag system of claim 19 wherein the airbag is configured to bend upwardly relative to the structure in response to the occupant contacting the airbag during the dynamic event.
